(19) United States
(12) Patent Application Publication
(10) Pub. No.: US 2005/0060919 A1
(43) Pub. Date: Mar. 24, 2005

(54) Greeting card incorporating ultraviolet light emitting diode

(76) Inventors: Sun Yu, Berkley, MI (US); David A. Perrin, Troy, MI (US)

Correspondence Address: GIFFORD, KRASS, GROH, SPRINKLE;ANDERSON & CITKOWSKI, PC, 280 N OLD WOODARD AVE, SUITE 400, BIRMINGHAM, MI, 48009, US

(21) Appl. No.: 10/668,522

(22) Filed: Sep. 23, 2003

(51) Int. Cl. G09F 1/00

(52) U.S. Cl. 40/124.02; 40/124.09

(57) ABSTRACT

A greeting card includes a substrate sheet having indicia printed thereon with a first ink readable under visible light and having indicia printed thereon with a second ink visible under ultraviolet light. An ultraviolet light emitting diode flashlight emitting a wavelength under which the second ink is visible is secured to the substrate. The ultraviolet light emitting diode is secured to the greeting card substrate by way of a flap extending therefrom or through the use of a hook and loop fastener. A commercial package including such a greeting card also has therewith a pen having an ink visible under illumination from the ultraviolet light emitting diode flashlight.

### FIELD OF THE INVENTION

The present invention generally relates to printed material, and in particular to a substrate having indicia printed thereon that is readable under ultraviolet light and such an ultraviolet light attached thereto.

### BACKGROUND OF THE INVENTION

Greeting cards have traditionally divided a sentiment into a preamble and a body with the preamble being expressed on a first side of a substrate and the body of the sentiment appearing on either the back side of a card-like substrate or in the interior of a folded substrate. In this way, the mechanical act of flipping the substrate to expose the body of the sentiment is used to create a dramatic pause and surprise.

The prior art contains numerous examples of methods to enhance the impact associated with the body of the sentiment through the inclusion of a visible light source between superimposed pages. Representative of this prior art are U.S. Pat. Nos. 4,209,824; 4,286,399; and 4,363,081. Such light sources have typically been incorporated directly into the context of the card, for example, as lights on a Christmas tree or projecting through cutouts so as to appear as lighted windows in a distant building.

Writing with an ultraviolet (UV) visible ink allows one to hide information in plain sight since the UV visible ink written indicia only become perceivable under incident UV light. While UV visible ink has long been used in cryptography and security marking of financial instruments, UV visible inks are largely unknown in the context of greeting cards. This situation is understandable since UV light sources until recently have been both cumbersome and expensive, as compared to a greeting card. Indicia written in UV visible ink that becomes readable under UV light allows one to design a greeting card where the body of the sentiment remains hidden in plain sight while a sentiment preamble written in conventional visible ink is read. Thus, there exists a need for a greeting card having indicia thereon written in UV visible ink, where the greeting card has a compact UV light source capable of visualizing the invisible ink attached to the greeting card.

### SUMMARY OF THE INVENTION

A greeting card includes a substrate sheet having indicia printed thereon with a first ink readable under visible light and having indicia printed thereon with a second ink visible under ultraviolet light. An ultraviolet light emitting diode flashlight emitting a wavelength under which the second ink is visible is secured to the substrate. The ultraviolet light emitting diode is secured to the greeting card substrate by way of a flap extending therefrom or through the use of a hook and loop fastener. A commercial package including such a greeting card also has therewith a pen having an ink visible under illumination from the ultraviolet light emitting diode flashlight.

### BRIEF DESCRIPTION OF THE DRAWINGS

FIG. 1 is a perspective partial cutaway view of an inventive greeting card;

FIG. 2 is a planar view of the flat stock forming the ultraviolet light emitting diode flashlight container of FIG. 1;

FIG. 3 is a planar view of another embodiment of inventive greeting card;

FIG. 4 is an exploded view of a miniature ultraviolet light emitting diode flashlight as depicted in the embodiments shown in FIGS. 1 and 3; and

FIGS. 5A and 5B are partial cutaway and perspective views of an alternate embodiment of an inventive greeting card.

### DETAILED DESCRIPTION OF THE PREFERRED EMBODIMENTS

The present invention has utility as a greeting card conveying a preprinted or personalized indicia visible under ultraviolet (UV) light illumination. A surface of a greeting card has indicia printed thereon in ink viewable under visible light. Indicia printed in ink visible under ultraviolet illumination are also printed on an inventive greeting card surface.

As used herein, “ink” is defined to encompass inks, dyes, and pigments.

As used herein, “ultraviolet” is defined to include light having wavelengths of between 350 and 400 nanometers.

A miniature ultraviolet light emitting diode (UV LED) flashlight is attached to the greeting card in such a way that when the card lies flat on a horizontal support, illumination from the UV LED flashlight illuminates the indicia visible only under UV light.

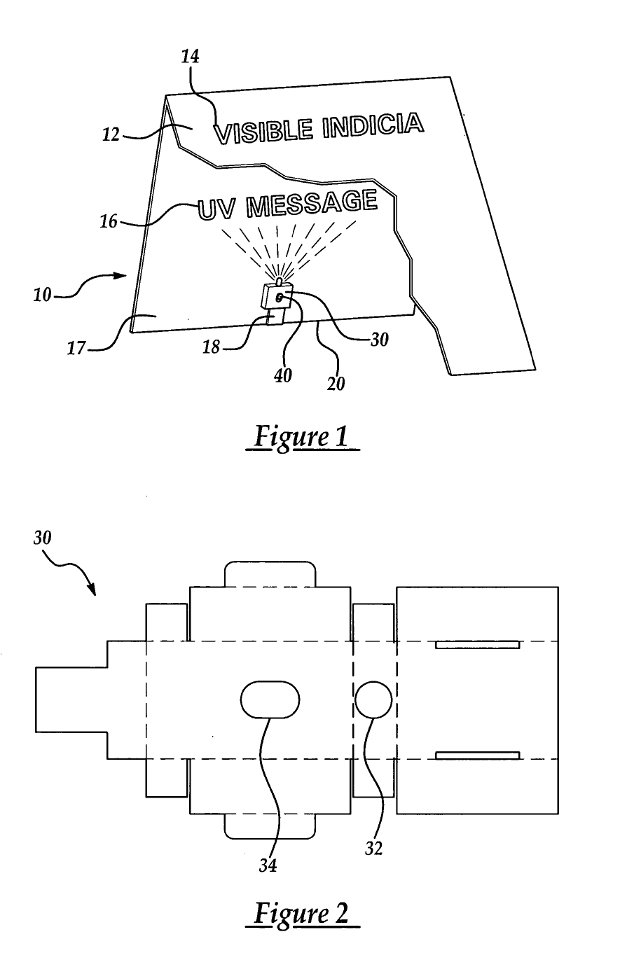

Referring now to FIGS. 1 and 2, an inventive greeting card is shown generally at 10. The greeting card 10 has a first writing surface 12 having printed thereon indicia viewable under visible light and printed indicia visible under UV illumination 16. In another inventive embodiment, the UV indicia 16 are present on a second writeable surface 17 of the greeting card 10. The greeting card 10 has a flap 18 extending from an edge 20 of the greeting card 10. The flap 18 secures a UV LED flashlight 60 to the greeting card 10. The flashlight is secured to the flap 18 in such a way that when the greeting card 10 rests on a horizontal surface, emission from the flashlight 60 projects onto the indicia visible under UV light 16. While it is appreciated that a flashlight is directly secured to the flap 18 through a contact adhesive or a hook and loop fastener, in a preferred embodiment a carton 30 for a flashlight is preferably formed from precut flat stock, as shown in FIG. 2. The flat stock is configured to have an aperture for LED protrusion 32. A further aperture 34 is provided to allow access to an activation switch of the flashlight. More preferably, the carton 30 has decorative or informative indicia printed thereon.

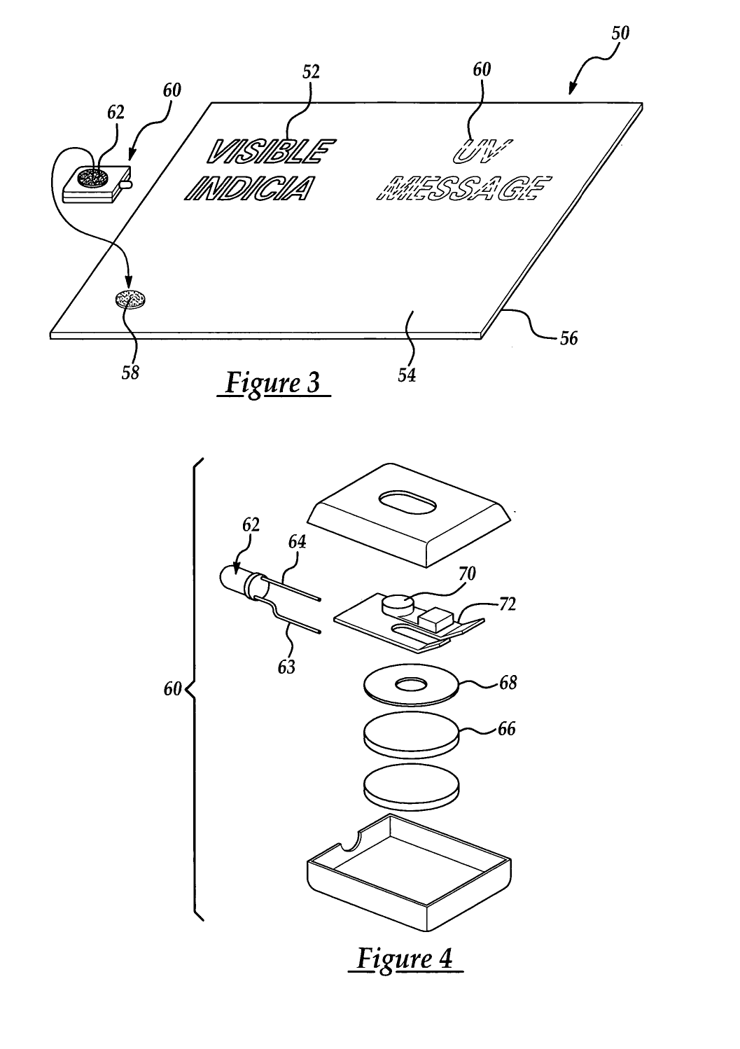

In an alternate embodiment of the present invention depicted in FIG. 3, the greeting card is shown generally at 50 having visible indicia 52 printed on a first surface 54 of a substrate 56. The visible indicia 52 typically including imagery and/or a sentiment preamble. Also on the first writing surface a first portion of hook and loop fastener 58 is affixed to the first writing surface 54 of the substrate 56. A miniature UV LED flashlight 60 has a complementary second portion of hook and loop fastener 62 attached thereto such that bringing the second portion 62 of hook and loop fastener in contact with the first portion of hook and loop fastener 58 attached to the substrate 56 selectively secures the flashlight 60 to the substrate 56. Preferably, the flashlight 60 is oriented relative to the first writing surface 54 so as to project UV emission from the flashlight 60 across the plane of the first writing surface 54. Indicia visible under ultraviolet illumination such as that provided by the flashlight 60 is also present on the first writing surface 54. In a preferred embodiment, the ultraviolet readable indicia 64 incorporate the body of the sentiment. As a result, the anticipation associated with the greeting card 50 is not diminished through having to leave the first writing surface 54 to reveal the body of the sentiment printed either on the reverse side or an interior fold of a greeting card.

A UV flashlight operative in the present invention is shown in FIG. 4 generally at 60. The flashlight 60 has a UV LED 62 having spaced leads 63 and 64. At least one battery affording sufficient voltage to drive the UV LED is interspersed between the leads 63 and 64. A washer 68 formed of an insulating material is intermediate between the lead 64 and a pole of battery 66. A switch 70 having a conductive plate 72 engages the lead 64. These components are encased within a lower housing portion 72 and an upper housing portion 74. The upper housing portion 74 having an aperture therein for a button portion 76 of said switch 70 to protrude therethrough. Thus, lateral motion of the button portion 70 of the switch 70 brings lead 64 into contact with a pole of the battery 66 by way of the metal strip 72 aligning with the hole in insulating washer 68 thereby completing a circuit and energizing LED 62. The housing portions 72 and 74 are secured together through various means conventional to the art illustratively including sonic welding, contact adhesives, and/or interlocking posts and holes.

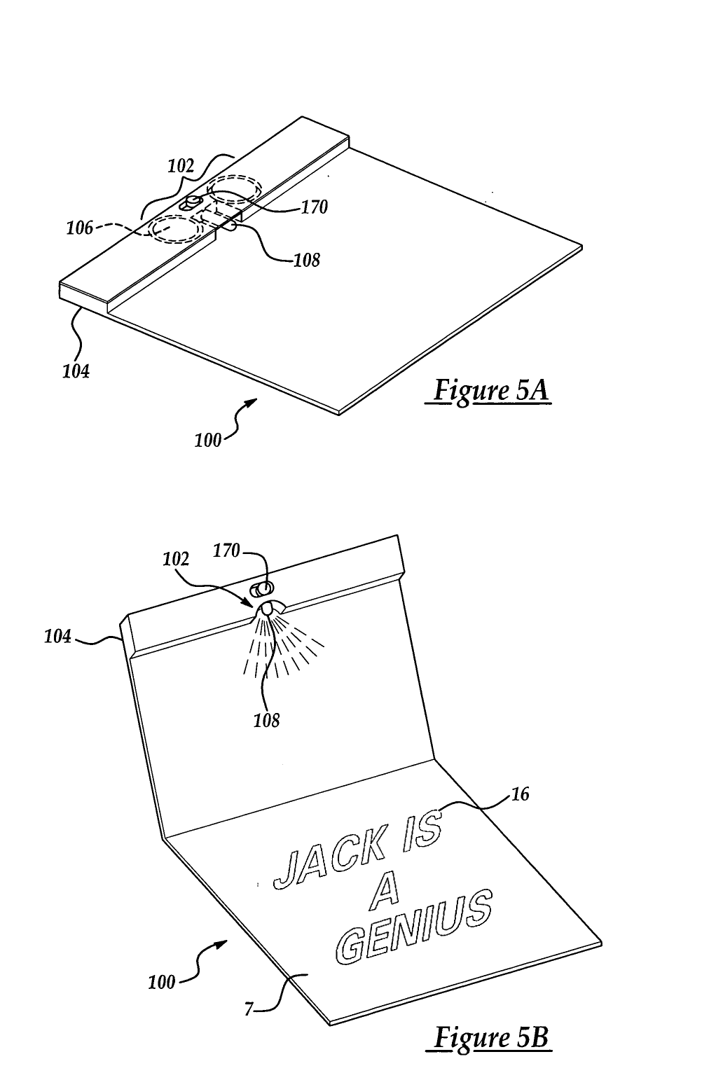

In another embodiment of the present invention depicted in FIGS. 5A and 5B, the greeting card is shown generally at 100, where like numerals correspond to the meanings previously ascribed thereto. UV indicia 16 are present on a second writeable surface 17. A miniature LED flashlight 102 is integrated into an overlying folded portion of flat stock 104. The flashlight 102 includes at least one button-type battery 106 which yields a sufficient voltage to energize the UV LED 108. The flashlight 102 is preferably positioned within an edge rail built up relative to the folded portion 104 so as to accommodate the at least one battery 106 of the flashlight 102. More preferably, the flashlight is positioned to project light onto the second writeable surface 17. A conventional spring loaded switch 170 activates the flashlight 102 upon the folded portion 104 being removed from contact with the second writeable surface 17.

A commercial package according to the present invention includes an inventive greeting card and a security marker pen that includes an ink or dye that becomes readable under ultraviolet light such as that provided by a UV LED. The commercial package further includes instructions as to illuminating a writing surface with the emission from a UV LED flashlight, followed by the inclusion of a personalized UV visible indicia. Thereafter, the UV LED is deactivated and the inventive greeting card is then optionally included within an envelope and conveyed to the recipient.

The foregoing discussion is merely meant to illustrate particular embodiments of the invention, and are not meant to be limitations on the practice thereof. It is the following claims, including all equivalents thereof, which define the scope of the invention.

1. An illuminated greeting card comprising:
a substrate sheet having indicia formed of a first ink readable under visible light and having indicia thereon formed of a second ink readable under light having a wavelength of between 350 and 400 nanometers; and
an ultraviolet light emitting diode flashlight having a light emission of between 350 and 400 nanometers.

2. The greeting card of claim 1 further comprising a securement for retaining said ultraviolet light emitting diode flashlight in contact with said substrate.

3. The greeting card of claim 1 wherein said substrate sheet has a fold line therein.

4. The greeting card of claim 1 further comprising a carton containing said ultraviolet light emitting diode flashlight, said carton adhered to said securement.

5. The greeting card of claim 1 wherein said securement is a flap extending from said substrate.

6. The greeting card of claim 5 wherein said flashlight is attached to said flap such that said substrate sheet in a horizontal position has illumination from said flashlight extending over the surface thereof.

7. The greeting card of claim 1 wherein said securement is a hook and loop fastener.

8. The greeting card of claim 1 wherein said flashlight is integrated with a folded portion of flat stock comprising said substrate sheet.

9. The greeting card of claim 1 further comprising a second ply affixed to the rear of said substrate with said flashlight retained between said substrate and said second ply, wherein said substrate has an aperture or a transparent region to allow for emission from said flashlight to illuminate a writing surface of said substrate sheet.

10. The greeting card of claim 1 further comprising a third ink readable under incident light having a wavelength of between 350 and 400 nanometers, said third ink having a color different than said second ink under illumination from a single light source.

11. An illuminated greeting card comprising:
a folded substrate having an outer writing surface and an inner writing surface, wherein at least one of the exterior writing surface and the interior writing surface has thereon indicia formed of a first ink readable under visible light and indicia formed of a second ink visible under incident light having a wavelength of between 350 and 400 nanometers;
an ultraviolet light emitting diode flashlight having a light emission of between 350 and 400 nanometers; and
a securement retaining said ultraviolet light emitting diode flashlight oriented such that when said substrate is horizontal, emission from said flashlight illuminates at least one of the exterior writing surface and the interior writing surface.

12. The greeting card of claim 11 wherein said flashlight is integrated with a folded portion of flat stock comprising said substrate sheet.

13. A commercial package comprising an illuminated greeting card according to claim 1 and a pen comprising an ink visible under incident light having a wavelength of between 350 and 400 nanometers along with instructions for writing with said pen on said greeting card.
